(19) United States
(12) Patent Application Publication
(10) Pub. No.: US 2014/0063198 A1
(43) Pub. Date: Mar. 6, 2014

(54) CHANGING PERSPECTIVES OF A MICROSCOPIC-IMAGE DEVICE BASED ON A VIEWER' S PERSPECTIVE

(71) Applicants: Catherine N. Boulanger, Redmond, WA (US); Paul Henry Dietz, Redmond, WA (US); Steven Nabil Bathiche, Kirkland, WA (US)

(72) Inventors: Catherine N. Boulanger, Redmond, WA (US); Paul Henry Dietz, Redmond, WA (US); Steven Nabil Bathiche, Kirkland, WA (US)

(73) Assignee: MICROSOFT CORPORATION, Redmond, WA (US)

(21) Appl. No.: 13/598,898

(22) Filed: Aug. 30, 2012

(51) Int. Cl. H04N 13/02

(52) U.S. Cl. 348/47; 348/46; 348/E13.074

(57) ABSTRACT

This document describes various apparatuses and techniques for changing perspectives of a microscopic-image device based on a viewer's perspective. Various embodiments of these techniques sense a change to a viewer's perspective based on the viewer's head position and control a microscopic-image device effective to display images of an object based on the change to the viewer's perspective.

### BACKGROUND

Optical inspection microscopes have long been used in industry and medicine to provide a magnified view of a region of interest, such as parts of a printed circuit board, skin, or muscle. More recently, stereo optical inspection microscopes have been used, thereby providing a three dimensional, magnified view of a region of interest. These stereo microscopes, however, still suffer from limitations. Occlusions can make some features difficult or impossible to see without repositioning the object being viewed. Furthermore, many people are unable to take full advantage of these stereo microscopes due to having poor vision in one eye or problems with eye-to-eye coordination.

### SUMMARY

This document describes various apparatuses and techniques for changing perspectives of a microscopic-image device based on a viewer's perspective. These apparatuses and techniques enable a viewer, even a viewer with some vision problems, to view a region of interest from different perspectives. These different perspectives can be provided in real time as a viewer moves his or her head. In so doing, a viewer may “look around” occlusions and so forth without repositioning the object being viewed. Also, these apparatuses and techniques enable a viewer to use motion parallax to sense the region in three dimensions.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit of a reference number identifies the figure in which the reference number first appears. The use of the same reference number in different instances in the description and the figures may indicate similar or identical items.

FIG. 1 illustrates an example environment in which these techniques may be implemented.

FIG. 2 illustrates an example desktop computer, display, sensor that collects viewer positional data, and a viewer.

FIG. 3 illustrates an example display that is capable of providing 3D images without use of special eyewear.

FIG. 4 is a flow diagram depicting example methods for changing perspectives of a microscopic-image device based on a viewer's perspective.

FIG. 5 illustrates an example viewer, microscopic-image device, display, and circuit board.

FIG. 6 is flow diagram depicting example methods for changing perspectives of a microscopic-image device based on a viewer's perspective, including based on real-time changes in a viewer's head position.

FIG. 7 illustrates an example device in which techniques for changing perspectives of a microscopic-image device based on a viewer's perspective can be implemented.

### DETAILED DESCRIPTION

Overview

This document describes various apparatuses and techniques for changing perspectives of a microscopic-image device based on a viewer's perspective. Various embodiments of these techniques sense a change to a viewer's perspective based on the viewer's head position and control a microscopic-image device effective to display images of an object based on the change to the viewer's perspective.

In some embodiments, these apparatuses include an electronic or partially electronic (rather than fully optical) microscope-image device having an electronic image sensor, an actuator, and a controller in communication with a display and a sensor capable of sensing a viewer.

Assume, for a first example, that a technician is using this apparatus to solder a computing chip to a circuit board. The technician views the region of the chip and circuit board in two or three dimensions on the display, depending on whether the apparatus includes one or two electronic image sensors. Assume also that the technician is soldering the chip to the board with both hands using delicate instruments while looking at the display and not the chip or board. Assume that at some point the technician needs to see around a capacitor structure that is occluding a solder point. Rather than have to use his or her hands to manipulate the circuit board to see around the capacitor structure, which would require the technician to stop working with one or both of his or her hands, the technician can move his or her head relative to the capacitor structure on the display as if he or she were looking around the capacitor structure on the circuit board. The sensor senses the change in the viewer's perspective and transmits this data to the controller, after which the controller controls the actuator to move the electronic image sensor to a perspective that roughly matches that of the viewer. By so doing, the viewer may see around the capacitor structure to view the solder point.

Assume, for a second example, that a surgeon is using this apparatus as part of an endoscope to perform a minimally invasive surgery. The surgeon can use his or her hands to perform the surgery and use his or her head to cause a change in perspective of a camera. By so doing, the surgeon may better view the organ or mass of interest and without having to interrupt use of the surgeon's hands.

In either of these or other example cases, the viewer may move his or head back and forth to gain a real-time change in views. These view changes provide motion parallax for the viewer, which enables the viewer to sense the object in three dimensions even if the display provides only a two-dimensional image or to better sense the object in three dimensions than with a static three-dimensional image.

Example Environment

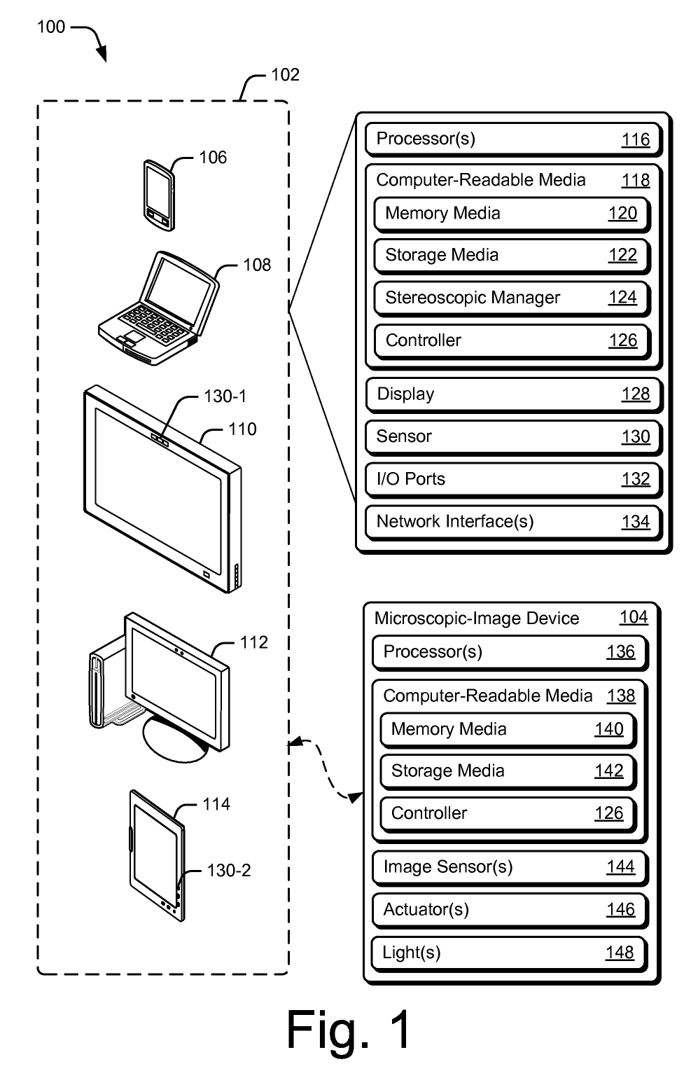

FIG. 1 is an illustration of an example environment 100 in which changing perspectives of a microscopic-image device based on a viewer's perspective can be implemented. Environment 100 includes a display device 102 and a microscopic-image device 104. Display device 102 is illustrated, by way of example and not limitation, as one of a smart phone 106, laptop computer 108, television device 110, desktop computer 112, or tablet computer 114. Generally, display device 102 can provide one or more of two-dimensional (2D) or three-dimensional (3D) content to viewers. In one non-limiting embodiment, display device 102 provides 3D content to a viewer without the use of special 3D eyewear. 3D content may comprise images (e.g., stereoscopic imagery) and/or video effective to cause a viewer to be able to perceive depth within the content when displayed.

Display device 102 includes processor(s) 116 and computer-readable media 118, which includes memory media 120 and storage media 122. Applications and/or an operating system (not shown) embodied as computer-readable instructions on computer-readable memory 118 can be executed by processor(s) 116 to provide some or all of the functionalities described herein. Computer-readable media 118 also includes stereoscopic manager 124 and controller 126. Stereoscopic manager 124 enables display of images in three dimensions without special eyewear, though this is not required for operation of the apparatuses or techniques described herein. Controller 126 can be included within, or in communication with, display device 102 and/or microscopic-image device 104. How controller 126 is implemented and used varies, and is described in greater detail below.

Display device 102 also includes display 128, sensor 130, input/output (I/O) ports 132, and network interface(s) 134. Display 128 is capable of rendering images in two or three dimensions (2D or 3D). When generating images in 3D, display 128 may do so using conventional manners (e.g., using special eyewear) or by generating stereoscopic 3D content that can be viewed without the use of special eyewear. Display 128 may be separate or integral with display device 102; integral examples include smart phone 106, laptop 108, and tablet 112; separate examples include television device 110 and, in some instances, desktop computer 112 (e.g., when embodied as a separate tower and monitor as shown).

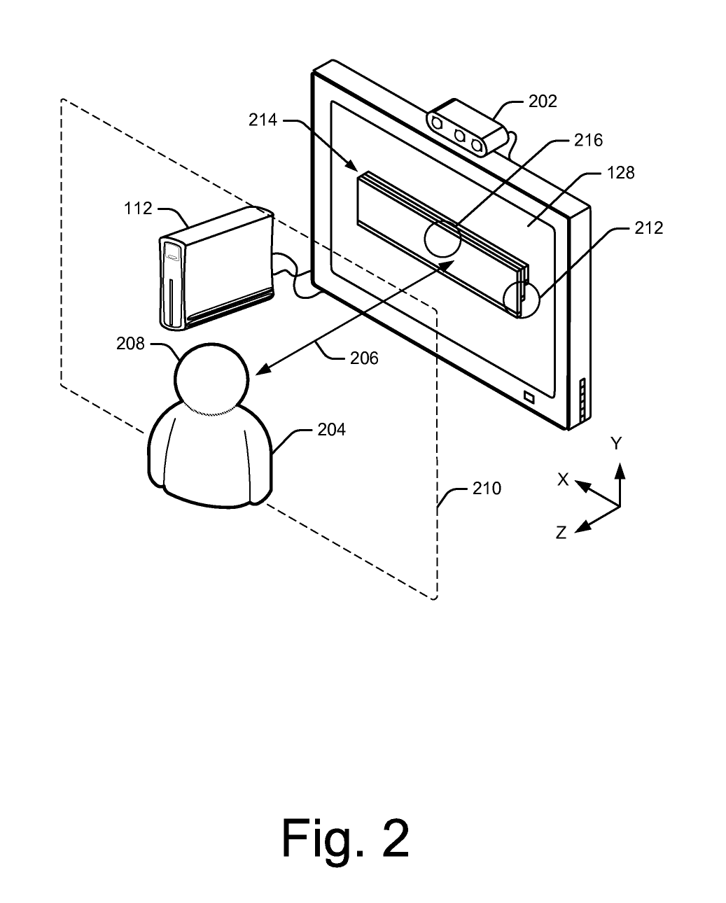

Sensor 130 collects viewer positional data useful to determine a perspective of a viewer, such as relative to display 128. Consider some examples of viewer positional data as illustrated in FIG. 2. FIG. 2 illustrates desktop computer 112, display 128, an example sensor 202 that collects viewer positional data, and a viewer 204. Note that a distance 206 between a viewer's head 208 and display 128 can be collected and/or determined and also that this distance 206 can be relative to display 128 based on plane 210, which is parallel to display 128. This distance 206 is a relative Z position, placement left-to-right within plane 210 of the viewer's head 208 is a relative X position, and placement up-and-down within plane 210 is a relative Y position. Viewer positional data is not limited to X, Y, and Z axes and can include, by way of example, a viewer's eye position (e.g., where the viewer's eyes are looking), or a pitch, yaw, or roll of head 208, to name but a few. While sensor 202 is described with extensive capabilities, many embodiments of the described techniques and apparatus may be performed with a simple and/or inexpensive type of sensor 130, such as a webcam. Example simple types of sensors are illustrated in FIG. 1 with sensor 130-1 and 130-2, both of which are integral with display device 102.

Positional data from sensor 202 can be used to determine the viewer's position relative to a portion of display 128, such as a particular object or region thereof that is displayed on display 128. Thus, viewer 204 may move head 208 relative to region 212 of object 214, rather than relative generally to display 128. Viewer positional data may be used to determine this movement relative to region 212, which controller 126 may use to alter a perspective of microscopic-image device 104 based on region 212 rather than a center point 216 of display 128.

Returning to FIG. 1, sensor 130 may be separate or integral with display device 102; integral examples include sensor 130-1 of television device 110 and sensor 130-2 of tablet computer 114; separate examples include stand-alone sensors, such as sensors operably coupled with display device 102, a set-top box, or a gaming device.

Sensor 130 can collect viewer positional data by way of various sensing technologies, either working alone or in conjunction with one another. Sensing technologies may include, by way of example and not limitation, optical, radio-frequency, acoustic (active or passive), micro-electro-mechanical systems (MEMS), ultrasonic, infrared, pressure sensitive, and the like. In some embodiments, sensor 130 may receive additional data or work in conjunction with a remote control device or gaming controller associated with one or more viewers to generate the viewer positional data.

Content (e.g., 2D or 3D images) is received by display device 102 of display device 102 via one or more I/O ports 132 from microscopic-image device 104. I/O ports 132 of display device 102 also enable interaction generally with microscopic-image device 104, such as providing control or viewer positional data. I/O ports 132 can include a variety of ports, such as by way of example and not limitation, high-definition multimedia (HDMI), digital video interface (DVI), display port, fiber-optic or light-based, audio ports (e.g., analog, optical, or digital), USB ports, serial advanced technology attachment (SATA) ports, peripheral component interconnect (PCI) express based ports or card slots, serial ports, parallel ports, or other legacy ports.

Display device 102 may also include network interface(s) 134 for communicating data over wired, wireless, or optical networks. Data communicated over such networks may include control, viewer positional data, and content that can be displayed or interacted with via display 128. By way of example and not limitation, network interface 134 may communicate data over a local-area-network (LAN), a wireless local-area-network (WLAN), a personal-area-network (PAN), a wide-area-network (WAN), an intranet, the Internet, a peer-to-peer network, point-to-point network, a mesh network, and the like.

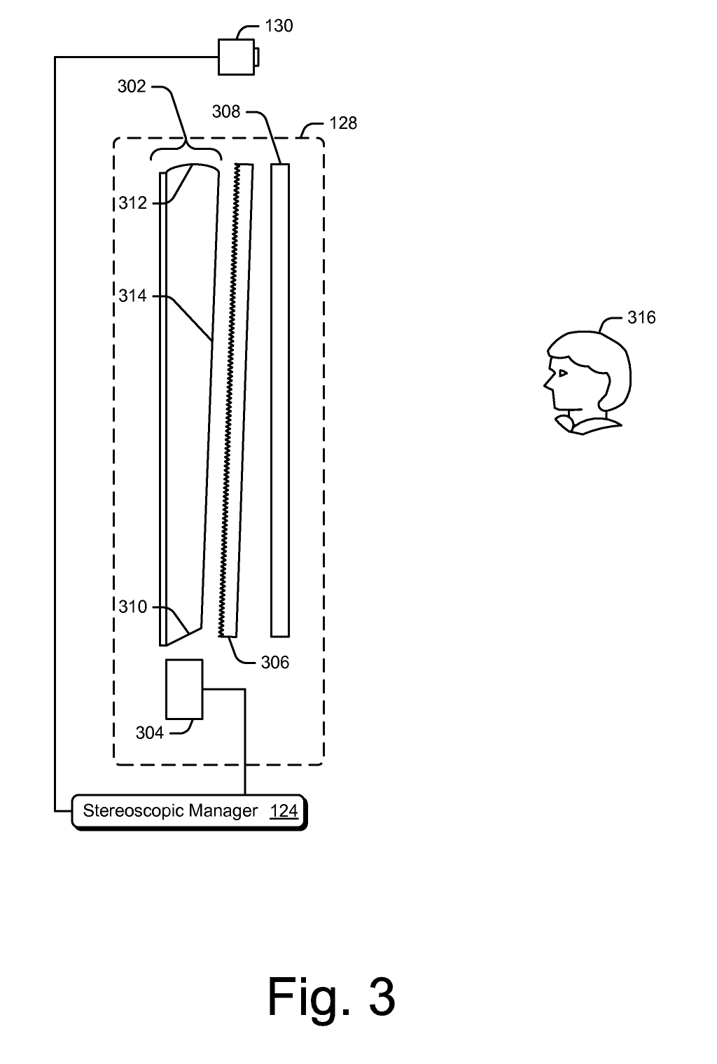

As noted above, in some embodiments display 128 is capable of providing 3D images without use of special eyewear. FIG. 3 illustrates a detailed example of this embodiment of display 128. Here display 128 includes lens structure 302, light injection system 304, light re-director 306, and spatial light modulator 308. Display 128 may be configured as a non-projection based flat panel display having a depth or thickness similar to that of a liquid crystal display (LCD) panel and the like. Lens structure 302 emits light from a surface when light is received from light injection system 304. The light emitted from lens structure 302 may be collimated light. In some case, lens structure 302 is an optical wedge having a thin end 310 to receive light, a thick end 312 effective to reflect the light (e.g., via an end reflector or reflective cladding), and a viewing surface 314 at which the light is emitted as collimated light.

In some implementations, an optical wedge may comprise an optical lens or light guide that permits light input at an edge of the optical wedge (e.g., thin end 310) to fan out within the optical wedge via total internal reflection before reaching the critical angle for internal reflection and exiting via another surface of the optical wedge (e.g., viewing surface 314). The light may exit the optical wedge at a glancing angle relative to viewing surface 314.

The light emitted by lens structure 302 can be scanned by varying light generated by light injection system 304 or an injection location thereof. Generally, scanning the light enables the display of 3D content that is viewable without the use of special eyewear. The scanned light enables display of different stereoscopic imagery to each eye of a respective viewer.

Spatial light modulator 308 modulates the light with visual information to form imagery displayed by the light converging on the eyes of a viewer 316. In some cases, the visual information is parallax information directed to different eyes of viewer 316 in order to provide the 3D content. For instance, spatial light modulator 308 can modulate light directed towards a viewer's left eye with a frame of stereoscopic imagery, and then modulate light directed to a viewer's right eye with another frame of stereoscopic imagery. Thus, by synchronizing scanning and modulation of light (collimated or otherwise), 3D content can be provided to a viewer.

In this particular example, stereoscopic manager 124 is operably coupled to light injection system 304 and sensor 130. In some cases, stereoscopic manager 124 is operably coupled with spatial light modulator 308 or a modulation-controller associated therewith. Stereoscopic manager 124 receives viewer position information, such as a distance to a viewer, collected by sensor 130 and can control light injection source 304 effective to display 3D imagery via display 128 over various distances.

As noted above, display 128 is not required to provide 3D images with or without use of special eyewear. Display 128 may also simply provide 2D images of an object or region thereof from a microscopic-image device.

Returning to microscopic-image device 104 of FIG. 1, microscopic-image device 104 is capable of providing images of an object from multiple perspectives. In some embodiments these multiple perspectives are provided by moving one or more image sensors. Alternatively or additionally, these multiple perspectives can be provided by an array of image sensors, each image sensor of the array having a different perspective. Further, while apparatuses and techniques described herein are described in the context of a microscopic-image device, these apparatuses and techniques may also or instead change perspectives of other image devices based on a viewer's perspective, including those providing other microscopic images (e.g., scanning electron microscope images) or non-microscopic images, such as non-magnified images, hi-definition video images, IMAX and other large-scene images, and so forth.

Microscopic-image device 104 includes processor(s) 136, computer-readable media 138 having memory media 140 and storage media 142, similarly to as set forth for display device 102 above. Computer-readable media 138 also includes controller 126, though controller 126 may operate also or instead from display device 102 and/or operate as hardware or firmware.

Microscopic-image device 104 also includes one or more image sensors 144, actuators 146, and lights 148. Image sensors 144 are capable of sensing images of an object from multiple perspectives. In some embodiments microscopic-image device 104 may forgo including actuator 146. In such a case, microscopic-image device 104 includes an array of multiple fixed image sensors, each of the fixed image sensors providing a different perspective of an object.

Actuator 146 is connected to a movable image sensor (or stereo set thereof) of image sensors 144. Actuator 146 is capable of moving image sensor 144 responsive to control by controller 126, such as around an object or portion thereof (e.g., object 214 or region 212 of FIG. 2).

Lights 148 can be stationary or movable depending on the configuration of microscopic-image device 104. In some cases each image sensor 144 includes a light 148 such that when (or if) image sensor 144 is moved, light 148 is also moved.

Controller 126 is capable of controlling image sensors 144, whether it is from one sensor, a set of stereo sensors, or an array of sensors. Also or instead, controller 126 may control an array of image sensors 144 without moving the sensors, such as by determining which image of image sensors 144 best matches a perspective of a viewer.

In more detail, controller 126 may receive viewer positional data from sensor 130. As noted, this viewer positional data indicates or is determinable to indicate a viewer's perspective. Controller 126 then determines which of multiple perspectives best matches the viewer's perspective, whether received from one of image sensors 144 that is moving or an array of image sensors 144 that are fixed or moving, and then causing display 128 to render the determined perspective.

In the case where controller 126 moves an image sensor, controller 126 causes actuator 146 to move the moveable image sensor effective to alter a perspective of the movable image sensor, the altered perspective being one of the multiple perspectives from which the controller is capable of determining the best match.

Example Methods

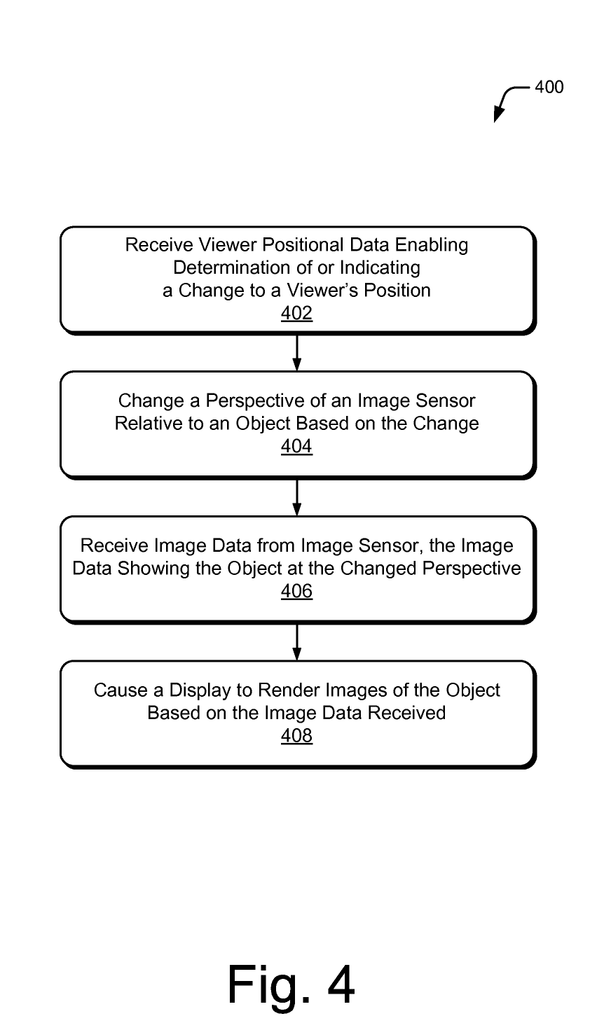

FIG. 4 is flow diagram depicting example methods 400 for changing perspectives of a microscopic-image device based on a viewer's perspective.

Block 402 receives viewer positional data, the viewer positional data enabling determination of, or indicating, a change in position of the viewer. This viewer positional data may be based on the viewer's head, eyes, or body position, for example. The change in position is relative to a display on which an image of an object is currently being rendered. As noted in part above in relation to FIG. 2, viewer positional data can indicate, or be used to determine, various positions, orientations and so forth.

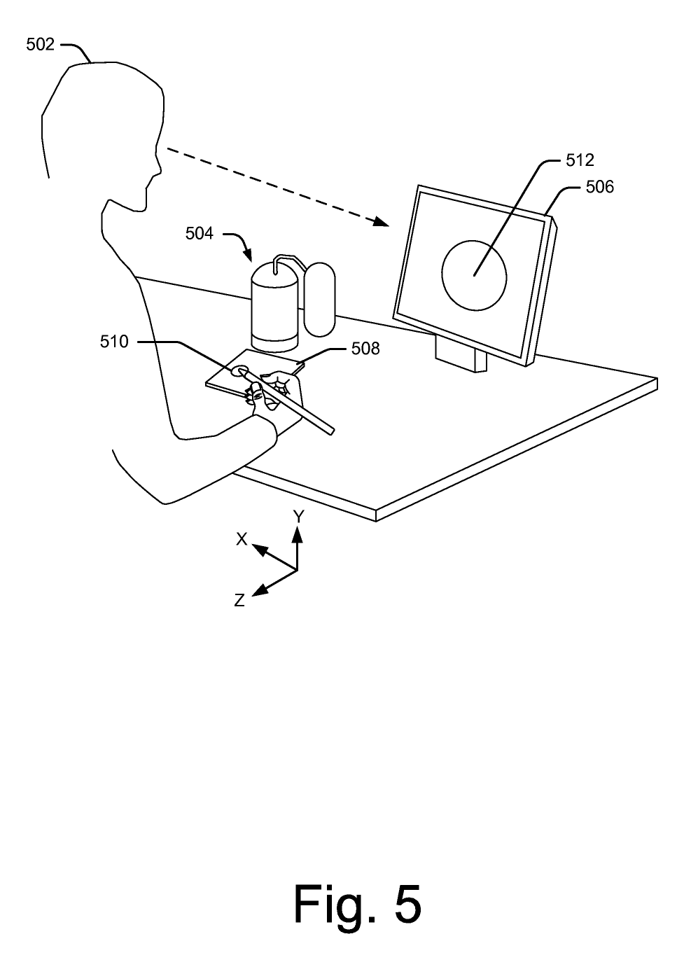

By way of example, consider FIG. 5, which illustrates an example viewer 502, microscopic-image device 504, display 506, and circuit board 508. Here viewer 502 is a technician soldering object 510 on circuit board 508. Note that the technician is looking at a magnified view 512 of object 510 on display 506 rather than object 510 on circuit board 508. In this example, controller 126 (of FIG. 1, not shown in FIG. 5) can receive viewer positional data and determine, based on the viewer positional data, the viewer's perspective. Controller 126 may do so, for example, based on multiple degrees of freedom of the head position of the viewer, such as a pitch, yaw, or roll, position in the X, Y, or Z axis (shown), head tilt, face angle, and eye position to name a few. For this example assume that viewer 502 moves his or her head along the X axis in an attempt to better view part of object 510. Other examples of viewer positional data and how it can be used are described below.

Block 404 changes a perspective of an image sensor relative to the object and based on the change in the viewer's position relative to the display. Continuing the example shown in FIG. 5, assume that microscopic-image device 504 includes a webcam and a servo motor (not shown), the webcam is a simple example of image sensor 144 and the servo motor an example of actuator 146, both described in relation to FIG. 1 above. Controller 126, at block 404, moves the webcam using the servo motor and based on the change in the head position of viewer 502 relative to the X axis. This movement can be linear along the X axis, thereby moving the webcam parallel to movement of the technician's head also along the X axis.

More generally, note that controller 126 need not move an image sensor in a same linear fashion as a viewer's head position. Assume that viewer positional data is received at block 402 indicating a linear movement of the viewer's head parallel to a display. In such a case, controller 126 may change the perspective of the image sensor relative to the object being sensed by the image sensor by moving the image sensor approximately in an arc about a pivot point approximately at the object, the arc not being linear relative to the object. Thus, this linear movement parallel to the display (e.g., within plane 210 of FIG. 2 or along X axis in FIG. 5), may be used by controller 126 to provide a perspective that is instead an arc about the object. Often a viewer moving parallel to the display does not intend to view an object at that perspective, but rather in an arc. A fully consistent perspective would cause an image sensor to move away from the object if the viewer moves away from a center point of a display, which provides a changing distance from the object along with a changing angle. An arc change in perspective, however, provides an approximately consistent distance from the object but with a changing angle.

In some cases, however, the viewer positional data indicates that the viewer is moving his or head in an arc about the display, an image of the object, or some region of the image of the object. In such a case controller 126 may follow that arc based on a determined portion of the object that correlates to an image pivot point of the viewer's movement about a location on the display. In so doing, controller 126 provides a perspective that is very similar to the head movement of the viewer.

Block 406 receives image data from the image sensor, the image data showing the object at the changed perspective. Thus, controller 126 may receive images from image sensors 144 and cause display 128 to render these images, which may be seamless and in real time, though that is not required. If controller 126 is within microscopic-image device 104, controller 126 receives data from sensor 130 through I/O ports 132 and/or network interfaces 134. If controller 126 is within display device 102, controller 126 sends commands to microscopic-image device 104 through these ports and/or interfaces.

Block 408 causes the display to render images of the object based on the image data received. Concluding the ongoing example, assume that an altered, magnified view from a different perspective is received at block 406 and that controller 126, at block 408, renders the altered, magnified view on display 506 (not shown).

As noted above, the image data from the image sensor may include stereo or mono images, and may be displayed as 2D, 3D, or 3D without use of special eyewear. Also, as noted in part above, the techniques can provide motion parallax of the object to a viewer. If the viewer, for example, is unable to distinguish some aspect of an object, the viewer may move his or head, such as back-and-forth, and so distinguish the aspect. Motion parallax is a known effect used by humans and animals alike to distinguish objects in three dimensions and so is not described in detail herein.

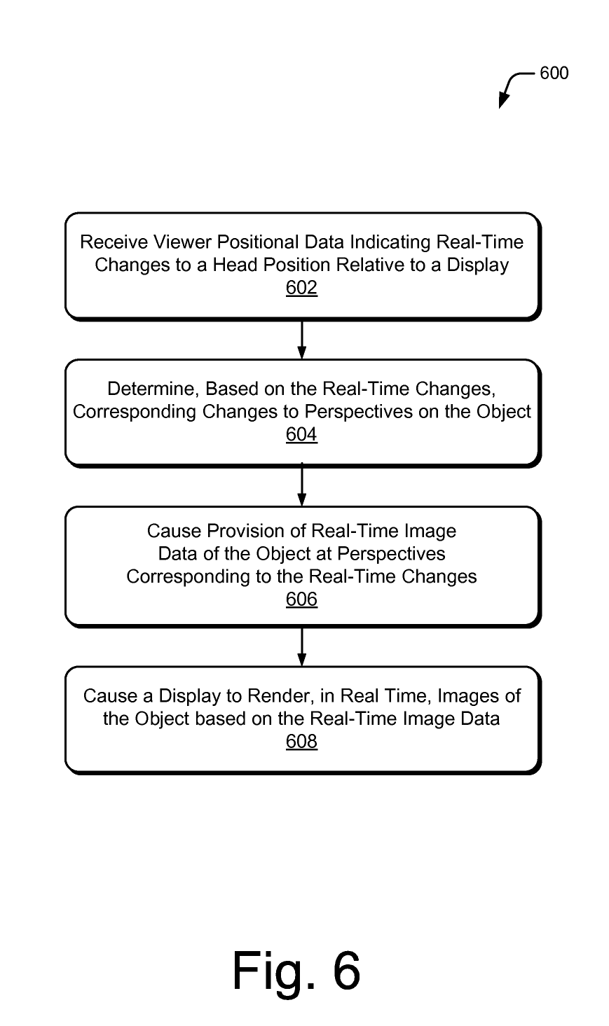

FIG. 6 is flow diagram depicting example methods 600 for changing perspectives of a microscopic-image device based on a viewer's perspective, including based on real-time changes in a viewer's head position. Methods 400 and 600, as well as operational aspects described elsewhere herein, may be implemented separately or in conjunction, whether in whole or in part.

Block 602 receives viewer positional data from a sensor, the viewer positional data enabling determination of or indicating real-time changes in a head position of a viewer, the real-time changes in the head position relative to a display on which an image of an object is displayed in real time.

Block 604 determines, based on the real-time changes in the head position of the viewer, corresponding changes to perspectives of the object.

Block 606 causes a microscopic-image device to provide real-time image data of the object at perspectives corresponding to the real-time changes in the head position of the viewer or determines, from provided real-time image data, real-time image data of the object that are at perspectives corresponding to the real-time changes of the head position of the viewer.

Block 606 may be performed with one or more moving image sensors of the microscopic-image device or multiple fixed moving image sensors. Thus, in some cases, an array of fixed image sensors provide images from many perspectives of the object. In such a case, controller 126 determines which of the provided images correspond to the perspective of the viewer determined at block 604. In some other cases, controller 126 causes the microscopic-image device to provide the real-time image data either by moving a movable image sensor (or sensors) to the perspective determined at block 604 or causing the microscopic-image device to provide the real-time image data from the fixed image sensor or sensors of an array that correspond to the perspective determined at block 604 or filtering out those of the images that do not correspond to the determined perspective thereby leaving those images that do correspond.

Block 608 causes the display to render, in real time, images of the object based on the real-time image data, the images effective to provide motion parallax of the object on the display.

Various blocks of methods 400 and/or 600 may be repeated effective to continually provide images of an object rendered on a display at perspectives corresponding to the viewer's position relative to the display or portion thereof.

The preceding discussion describes methods in which the techniques may change perspectives of a microscopic-image device based on a viewer's perspective. These methods are shown as sets of blocks that specify operations performed but are not necessarily limited to the order shown for performing the operations by the respective blocks.

Aspects of these methods may be implemented in hardware (e.g., fixed logic circuitry), firmware, a System-on-Chip (SoC), software, manual processing, or any combination thereof. A software implementation represents program code that performs specified tasks when executed by a computer processor, such as software, applications, routines, programs, objects, components, data structures, procedures, modules, functions, and the like. The program code can be stored in one or more computer-readable memory devices, both local and/or remote to a computer processor. The methods may also be practiced in a distributed computing environment by multiple computing devices.

Example Device

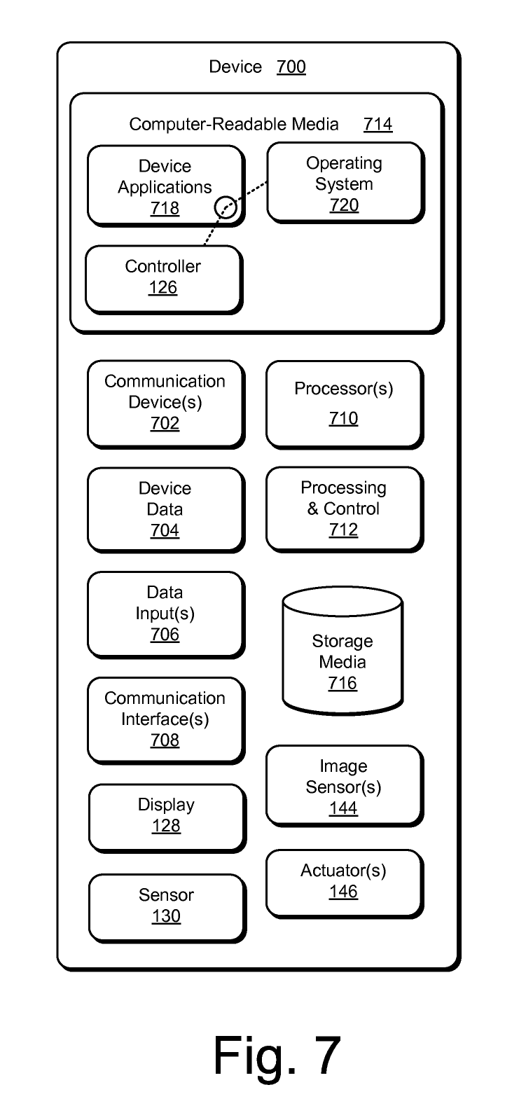

FIG. 7 illustrates various components of example device 700 that can be implemented as any type of client, server, and/or display device as described with reference to the previous FIGS. 1-6 to implement techniques for changing perspectives of a microscopic-image device based on a viewer's perspective. In embodiments, device 700 can be implemented as one or a combination of a wired and/or wireless device, as a form of flat panel display, television, television client device (e.g., television set-top box, digital video recorder (DVR), etc.), consumer device, computer device, server device, portable computer device, viewer device, communication device, video processing and/or rendering device, appliance device, gaming device, electronic device, and/or as another type of device. Device 700 may also be associated with a viewer (e.g., a person or user) and/or an entity that operates the device such that a device describes logical devices that include viewers, software, firmware, and/or a combination of devices.

Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a viewer of the device. Media content stored on device 700 can include any type of audio, video, and/or image data. Device 700 includes one or more data inputs 706 via which any type of data, media content, and/or inputs can be received, such as viewer-selectable inputs, position changes of a viewer, messages, music, television media content, recorded video content, and any other type of audio, video, and/or image data received from any content and/or data source.

Device 700 also includes communication interfaces 708, which can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like), which process various computer-executable instructions to control the operation of device 700 and to enable techniques for changing perspectives of a microscopic-image device based on a viewer's perspective. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable storage media 714, such as one or more memory devices that enable persistent and/or non-transitory data storage (i.e., in contrast to mere signal transmission), examples of which include random access memory (RAM), non-volatile memory (e.g., any one or more of a read-only memory (ROM), non-volatile RAM (NVRAM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable storage media 714 provides data storage mechanisms to store the device data 704, as well as various device applications 718 and any other types of information and/or data related to operational aspects of device 700. For example, an operating system 720 can be maintained as a computer application with the computer-readable storage media 714 and executed on processors 710. The device applications 718 may include a device manager, such as any form of a control application, software application, signal-processing and control module, code that is native to a particular device, a hardware abstraction layer for a particular device, and so on. The device applications 718 also include any system components or modules to implement these described techniques. In this example, the device applications 718 can include controller 126.

Furthermore, device 700 may include or be capable of communication with display 128, sensor 130, image sensor(s) 144, and/or actuator(s) 146.

### CONCLUSION

This document describes various apparatuses and techniques for changing perspectives of a microscopic-image device based on a viewer's perspective. Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving viewer positional data, the viewer positional data enabling determination of, or indicating, a change in a head position of a viewer, the change in the head position relative to a display on which an image of an object is currently being rendered;
changing a perspective of an image sensor relative to the object and based on the change in the head position relative to the display;
receiving image data from the image sensor, the image data showing the object at the changed perspective; and
causing the display to render images of the object based on the image data received.

2. A method as recited in claim 1, wherein receiving image data is received in real time and causing the display to render images causes the display to render the images in real time.

3. A method as recited in claim 1, wherein causing the display to render images presents the images effective to provide motion parallax of the object.

4. A method as recited in claim 1, wherein the viewer positional data enables determination of or indicates a linear movement parallel to the display and changing the perspective of the image sensor relative to the object moves the image sensor in an arc about a pivot point approximately at the object, the arc not being linear relative to the object.

5. A method as recited in claim 1, wherein the viewer positional data enables determination of or indicates an arced movement as the change in the head position of the viewer and changing the perspective of the image sensor relative to the object moves the image sensor in an arc about a pivot point approximately at the object.

6. A method as recited in claim 1, wherein the viewer positional data enables determination of or indicates an arced movement as the change in the head position of the viewer, the arced movement having an image pivot point at a location on the display and further comprising determining a portion of the object associated with the image pivot point about which the arced movement is arced, and wherein changing the perspective of the image sensor relative to the object moves the image sensor in an arc about an object pivot point approximately at the portion of the object associated with the image pivot point.

7. A method as recited in claim 1, wherein the viewer positional data includes multiple degrees of freedom of the head position of the viewer.

8. A method as recited in claim 1, wherein the image sensor is a stereo image sensor, the image data is stereo image data, and causing the display to render images causes the display to render stereo images of the object.

9. An apparatus comprising:
one or more image sensors capable of sensing images of an object from multiple perspectives; and
a controller capable of:
receiving viewer positional data, the viewer positional data enabling determination of or indicating a viewer's perspective;
determining which of the multiple perspectives best matches the viewer's perspective; and
causing a display to render the determined perspective.

10. An apparatus as recited in claim 9, further comprising an actuator connected to a movable image sensor of the one or more image sensors, and wherein the controller is further capable of causing the actuator to move the moveable image sensor effective to alter a perspective of the movable image sensor, the altered perspective being one of the multiple perspectives from which the controller is capable of determining the best match.

11. An apparatus as recited in claim 10, wherein the one or more image sensors include multiple movable image sensors.

12. An apparatus as recited in claim 10, wherein the one or more image sensors include only one image sensor, the one image sensor being the movable image sensor, the movable image sensor capable of sensing images of the object from the multiple perspectives through movement around the object caused by the actuator.

13. An apparatus as recited in claim 9, wherein the one or more image sensors include an array of multiple fixed image sensors.

14. An apparatus as recited in claim 9, wherein the viewer's perspective is relative to the object as the object is displayed on the display and determining which of the multiple perspectives best matches the viewer's perspective is based on the viewer's perspective relative to the object as the object is displayed on the display.

15. An apparatus as recited in claim 9, wherein the controller is further capable of determining the viewer's perspective based on a head position of the viewer relative to the display.

16. An apparatus as recited in claim 9, wherein the controller is capable of the receiving, the determining, and the causing in real time effective to provide motion parallax of the object on the display.

17. An apparatus as recited in claim 9, further comprising a sensor from which the viewer positional data is received and the display, the sensor being integral with the display.

18. A method comprising:
receiving viewer positional data, the viewer positional data enabling determination of or indicating real-time changes in a head position of a viewer, the real-time changes in the head position relative to a display on which an image of an object is displayed in real time;
determining, based on the real-time changes in the head position of the viewer, perspectives on the object corresponding to the real-time changes in the head position of the viewer;
causing a microscopic-image device to provide real-time image data of the object at the perspective on the object corresponding to the real-time changes in the head position of the viewer; and
causing the display to render, in real time, images of the object based on the real-time image data, the images effective to provide motion parallax of the object on the display.

19. A method as recited in claim 18, wherein the microscopic-image device includes an array of fixed image sensors, further comprising determining which of the fixed image sensors of the array correspond to the perspective on the object, and wherein causing the microscopic-image device to provide the real-time image data causes the determined fixed images sensors to provide the real-time image data.

20. A method as recited in claim 18, wherein the microscopic-image device includes a movable image sensor and causing the microscopic-image device to provide the real-time image data causes an actuator to move the movable image sensor to the perspectives on the object corresponding to the real-time changes in the head position of the viewer.
